(19) United States
(12) Patent Application Publication
(10) Pub. No.: US 2005/0228911 A1
(43) Pub. Date: Oct. 13, 2005

(54) Method and device for padding data segments with a fill pattern and subsequent over-writing with information, in addition to corresponding bus system

(76) Inventors: Thomas Fuehrer, GERLINGEN (DE); Robert Hugel, Karlsruhe (DE)

Correspondence Address: KENYON & KENYON, ONE BROADWAY, NEW YORK, NY, 10004, US

(21) Appl. No.: 10/510,659

(22) PCT Filed: Apr. 14, 2003
(86) PCT No.: PCT/DE03/01245

§ 371 Date: Jun. 9, 2005

(30) Foreign Application Priority Data
Apr. 15, 2002 (DE) 102 16 921.7

(51) Int. Cl. G06F 13/42

(52) U.S. Cl. 710/106

(57) ABSTRACT

A method and device are described for padding segments for transmitting data on a bus system and a bus system. The segments have a predetermined total number of bytes and the data being transmitted in segments, in the event of a transmission of data including fewer bytes than the predetermined total number of the segment, the missing bytes of the data being padded to the total number of the segment by a filling pattern of a corresponding byte number, distinguished in that a filling pattern, whose byte number corresponds to the total number of the segment, is first written into the segment and the bytes of the data are subsequently written into the same segment, the particular bytes of the filling pattern being overwritten by the bytes of the data.

### FIELD OF THE INVENTION

The present invention relates to a method and a device for padding segments for transmitting data on a bus system and a corresponding bus system.

### BACKGROUND INFORMATION

The networking of control devices, sensors, and actuators with the aid of a communication system, a bus system, has drastically increased in recent years in the construction of modem motor vehicles or even in mechanical engineering, in particular in the field of machine tools and in automation. Synergistic effects may be achieved in this case by distributing functions to multiple control devices. These are referred to as distributed systems. Different stations communicate increasingly via a bus or a bus system. The communication traffic on the bus system, access and receiving mechanisms, and error management are regulated via a protocol.

The CAN (controller area network) is established as the protocol in the field of motor vehicles. This is an event-controlled protocol, i.e., protocol activities such as the transmission of a message are initiated by events having their origin outside the communication system itself. The unique access to the communication system or bus system is triggered via priority-based bit arbitration. A requirement for this is that every message is assigned a unique priority. The CAN protocol is very flexible. Adding further nodes and messages is therefore possible without problems as long as there are still free priorities.

An alternative approach to such an event-controlled, spontaneous communication is the purely time-controlled approach. All communication activities on the bus are strictly periodic. Protocol activities such as the transmission of a message are triggered only by the progression of a time that is valid for the entire bus system. Access to the medium is based on the assignment of time ranges or time slots in which a transmitter has the exclusive transmission right. Adding new nodes is possible when the corresponding time slots were previously left free. This circumstance requires the message sequence to be established even before startup, an operating plan being prepared that must fulfill the requirements of the messages in regard to repetition rate, redundancy, deadlines, etc.

In addition to the event-controlled approach and the purely time-controlled approach, a time-controlled CAN approach, the TTCAN (time triggered controller area network), is also known. This fulfills the requirements described above for time-controlled communication and the requirements for a certain degree of flexibility. The TTCAN fulfills these requirements through the construction of the communication cycle (basic cycle) in exclusive time windows or time slots for periodic messages of specific communication users and in arbitrating time windows or time slots for spontaneous messages of multiple communication users.

In addition to the cited bus systems, a plurality of bus or communication systems for connecting users in distributed systems are known. In the framework of the cited bus systems and other bus systems, for example, before the background of the flexibility, the width of the time slots or of the segment provided for data transmission is selectable in each case through the total number of bits transmitted therein. However, if the width of the data segment or shorter segment or time slot is selected or preset, particularly during configuration, the length of the message transmitted therein is fixed by this selected total number of bits or the selected width. This means that longer messages must be distributed over multiple such segments and shorter messages must be padded in order to reach the total number of bits in the segment. This is referred to as padding. Such padding of missing data in a segment is described in regard to a bus system in U.S. Pat. No. 5,598,579. U.S. Pat. No. 6,349,348 also shows padding, i.e., the padding of missing data with a filling pattern if the data size is smaller than a predetermined size.

However, in this case, the actual data content is first copied into a memory or buffer, for example, and subsequently supplemented with the padding pattern or filling pattern in order to obtain the predetermined total number of bits or the total size of the segment. The following types of error may arise in this case, however:
Through the later addition of the filling pattern, the message content is partially overwritten resulting in an incorrect message content or data content.
The message or data content is completely overwritten, an incorrect data content or message content also resulting in this case.
Furthermore, the actual message length, i.e., the number of data bits, may be supplemented past the permissible length, further message contents or data contents of undefined content then arising, thereby also resulting in an incorrect message content or data content in this case.

Therefore, it has been shown that the cited related art is not capable of providing optimal results in every aspect, from which the object results of improving the situation, in particular of controlling the described sources and types of error.

### SUMMARY OF THE INVENTION

The present invention describes a method and a device for padding segments for transmission of data on a bus system, the segments having a predetermined total number of binary information pieces, particularly bytes, and the data being transmitted in segments, in the event of a transmission of data including less binary information, bytes in particular, than the predetermined total number of the segment, the missing binary information, bytes in particular, of the data being padded to the total number of the segment through a filling pattern corresponding to the number of binary information pieces, bytes in particular, a filling pattern whose number of binary information pieces, bytes in particular, corresponds to the total number of the segment first being written into the segment and the binary information, bytes in particular, of the data subsequently being written into the same segment, the particular binary information, bytes in particular, of the filling pattern being overwritten by the binary information, bytes in particular, of the data. Therefore, the above-mentioned error sources may advantageously be prevented, since the filling pattern is overwritten with the regular data and not vice versa.

Advantageously, in regard to a bus system according to the present invention, the binary information, bytes in particular, of the filling pattern and the binary information, bytes in particular, of the data is written in a buffer memory into the segment, and this segment is then transmitted out of the buffer memory to the bus system in the framework of the access and receiving mechanisms, i.e., at the instant provided.

This is advantageously a time-controlled bus system in this case, the segments corresponding directly to time slots on the bus system, the data being transmitted in the corresponding time slots. A bus system according to the present invention divides a communication cycle into a static segment and a dynamic segment in this case, a preset of the total number of bits of the segment that may be selected freely during configuration being made possible in the static segment in particular.

### BRIEF DESCRIPTION OF THE DRAWINGS

FIG. 1 shows a distributed system, i.e., a network or a bus system having at least one user and means for performing the method according to the present invention.

FIG. 2 shows an example of a communication cycle according to the present invention having segments lined up for data transmission.

### DETAILED DESCRIPTION

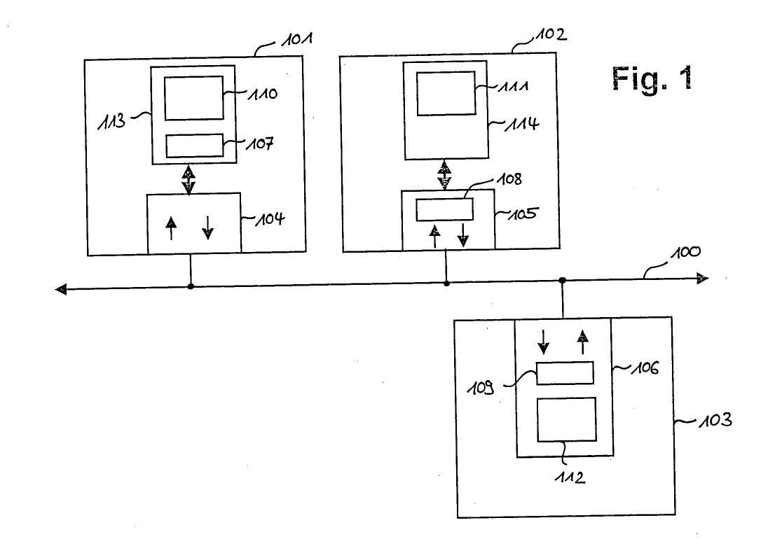

FIG. 1 shows a bus system 100 having a first user 101, a second user 102, and a third user 103, i.e., a distributed system. Since communication is possible via the users themselves or computing units or control units contained therein, as well as via separate control units, such as a bus controller, which is located internally or externally in relation to the users, the concepts of bus system and distributed system are used interchangeably in the following. This means that the bus system may be both the pure communication link to control units to maintain or produce communication and also the communication link to connected users, who in turn produce communication, as well as mixed systems including both variants.

Therefore, users 101 to 103 also represent three variants of user structures, further variants being immediately obvious and also usable via combination, but are not shown for reasons of clarity. User 101 shows an interface 104 to bus 100 having a processing unit 113, which contains a buffer memory 107 and a control unit or a microcomputer or a processor 110, which is shown separately from interface unit 104 in the first example. This means that communication is controlled in the user itself, for example. User 102 again shows an interface unit 105, which contains buffer memory 108 in this case. Processing unit 114 therefore does not contain the buffer memory, but merely control unit 111, i.e., the control may be performed by the user itself here, the buffering occurring in interface unit 105. Interface unit 104 or 105 itself may also be internally or externally located in relation to the user in this case. As a further example, user 103 shows an interface unit 106 which, in addition to buffer memory 109, also contains a processing unit, in particular a control unit such as a bus controller 112. In this case, the entire communication is therefore processed and controlled by interface unit 106. Interface unit 106 may also be positioned internally or externally in relation to user 103 in this instance. The processing units, in particular 110 and 111, are also able to process further tasks in addition to controlling communication.

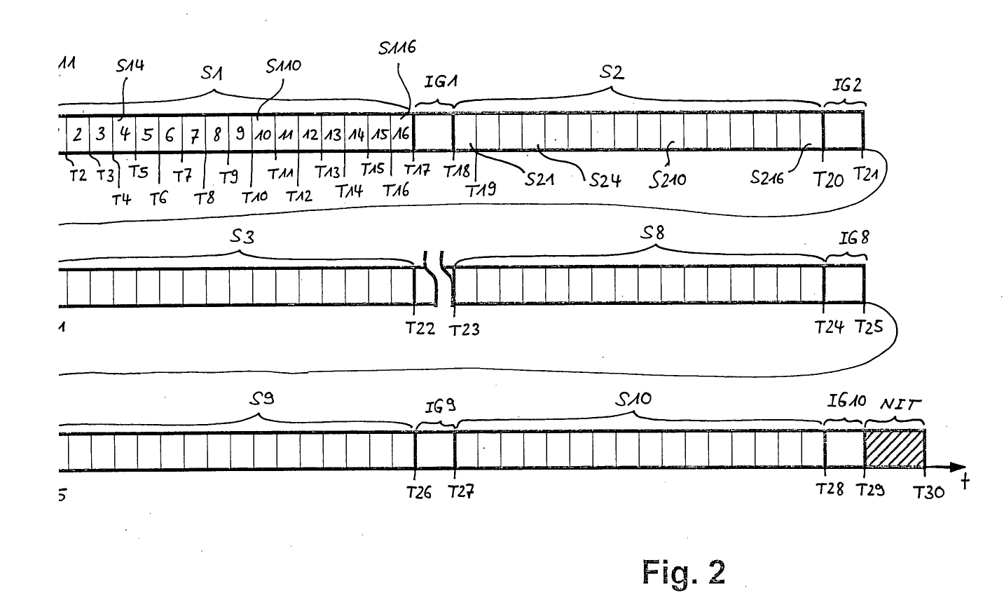

In the exemplary bus system shown in FIG. 1, an exemplary communication occurs in the course of a communication cycle as shown in FIG. 2. S1 through S10 show different segments, in particular time segments, i.e., time slots or slots for data transmission. In an exemplary specification for a bus system and a corresponding bus protocol, the static segment of a communication cycle or even the entire communication cycle is divided into N time units or time slots, in particular segments, slots, for data transmission, which are provided for the transmission of messages, i.e., data. A unique assignment of the user or bus node to the particular message, i.e., the data content, as well as the segment, i.e., slot S1 through S10, is possible in this case, in particular via an identifier, a frame ID. In this context, the segment width may be selected freely during configuration of the communication, the length of the messages transmitted therein in all segments of the static segment also being selected with the selected width, i.e., the total number of bits able to be transmitted in such a segment. This means that in this example, a static segment from T1 through T29 is shown having 10 segments or slots, the total duration of the segment corresponding to the length of slot S1 through S10 and an associated segment intermediate space, the interframe gap.

Furthermore, the length of a segment S1 through S10 is selected as 16 bytes and shown, for example, in first segment S1 from T1 through T17. Since interframe gap IG may be arbitrary, in particular even 0, only the data-carrying segment is identified as a segment in this example. However, the duration of the segment is actually the data-carrying segment plus the associated interframe gap, i.e., S1+IG1 in this case, which is followed by the next segment. This means that longer messages, i.e., in this example greater than 16 bytes in particular, must be distributed over a plurality of segments by a higher application layer, as this is performed in the course of message segmenting, e.g., by the FTCom Layer in OSEKtime. Shorter messages, i.e., shorter than 16 bytes in particular in this case, must be expanded or supplemented according to the specification, i.e., protocol guideline, i.e., the missing bytes must be padded to the greatest possible message length, also 16 bytes in this case, the padding cited. This means that the messages are transmitted in binary information in particular, i.e., bits or bytes, the size of the message segments being selectable arbitrarily, 16 bytes in this case.

Therefore, in the example cited here a selected division of the communication cycles occurs, i.e., a division into 10 segments or slots. In this case, the duration of a slot is the length of the 16-byte message plus associated interframe gap IG. Due to the possibility of the interframe gap being 0, segment and data segment are equivalent and are designated as S1 in this example. Therefore, the communication cycle is composed of 10×16 bytes plus the interframe gap, shown here from T29 through 30, a time period in which no message may be transmitted, known as network idle time NIT. This is optional, but shown herewith as a possible feature of the bus protocol. In this communication cycle, a configuration including only one static segment is assumed as an example. For reasons of clarity, a possible dynamic segment between the static segment and the network idle time, i.e., at T29, is not shown.

User 103 is, for example, a simple angle sensor in the motor vehicle, which only has a 2-byte message to transmit. Therefore, a message memory assigned to this sensor is also only tailored, specified, and implemented for this data width, for reasons of cost in particular. Nonetheless, this angle sensor must also behave on the presented bus system according to the specification, i.e., the bus protocol, and transmit a 16-byte message in its assigned segment, i.e., its transmission slot. For example, this slot is segment S1 plus associated interframe gap IG1 in this case. This means that shortly before transmission, the actual prepared message, for example, of exactly 2 bytes, i.e., from T1 through T3 in this case, i.e., bytes S1, S12, and S13, would be stored in the transmission buffer or transmission memory, this data content, i.e., the sensor value, then having to be padded or expanded by a further 14 bytes. In this case, according to the current procedure, the bytes would typically be placed left or right in the frame, i.e., by most significant bits, MSB, or least significant bits, LSB, which facilitates the further padding according to the current procedure. These used filling bytes, i.e., from S14 through S116 in the example, are referred to as padding bytes or also as the padding pattern or filling pattern, meaning a selected character segment that uniquely identifies the padding pattern or filling pattern, e.g., O×FF in hexadecimal representation. In the present case, sensor value 0×8005, corresponding to the angle information minus 0.5 degree in hexadecimal coding with a negative prefix, for example, would be supplemented using most significant bit, MSB (set for a negative number) to

0×80/05/FF/FF/FF/FF/FF/FF/FF/FF/FF/FF/FF/FF/FF/FF, supplemented in transmission memory or transmission buffer 109 in particular.

According to the current procedure if, as described above, the actual data content is copied into transmission buffer 109 and then supplemented with the padding pattern, incorrect padding may occur in case of error.

A) In this case, for example, the message content will be partially overwritten. In this example, an incorrect message content,

0×80/0F/FF/FF/FF/FF/FF/FF/FF/FF/FF/FF/FF/FF/FF/FF, arises. This means that the incorrect message content arising in this case will then be erroneously transmitted as sensor information, and the CRC, i.e., the cyclic redundancy check, calculated during transmission may not uncover this error. A plausibility test in the application may possibly uncover this error, but this is subject to great uncertainty.

B) Furthermore, the message content may also be completely overwritten, which then leads to 0×FF/F/FF/FF/FF/FF/FF/FF/FF/FF/FF/FF/FF/FF/FF/FF, through which an incorrect message content would again arise. The cyclic redundancy check calculated during transmission may not uncover this error and even a plausibility test in the application may not uncover this error.

C) Furthermore, it is possible that the message length will be supplemented beyond the permissible length. In this case, data contents or message contents of undefined content arise, such as 0×80/05/77/FF/FF/FF/FF/FF/FF/FF/FF/FF/FF/FF/FF/FF/FF, i.e., an incorrect message content also arises here. The cyclic redundancy check calculation merely occurs over the 16 bytes and may not uncover the error. The plausibility test may uncover this error, but only when the application checks beyond the actual message, i.e., the two bytes.

To achieve the object, the present invention suggests that the segment, i.e., the transmission buffer in particular in this case, be padded, and padded completely, with the filling pattern or padding pattern before each transmission procedure. In this context, of course, the predefined message or data width, i.e., 16 bytes in this case for example, must be maintained. This means that transmission slot or segment S1 of sensor 103 is now padded with a filling pattern or padding pattern, i.e., bytes S11 through S116. Only then will the message content, i.e., the sensor value of 2 bytes in this case, be copied at the correct point in the segment, i.e., in the transmission buffer in particular, thereby overwriting the padding or filling pattern at these points. Above-mentioned error cases A through C are therefore prevented. In addition, any arbitrary position may be predetermined for the data content, i.e., the actual sensor value to be transmitted, since the filling pattern is written first and a complicated subsequent padding with bytes in the course of the padding is no longer necessary.

Therefore, the simple method cited according to the present invention allows high reliability to be produced via a simple measure, in particular by design, the efficiency of the protocol execution not being endangered.

1-5. (canceled)

6. A method for padding segments for transmitting data on a bus system, the segments having a preset total number of binary information pieces, comprising:
transmitting the data in the segments; and
in the event of transmission of data including less binary information than a predetermined total number of the segments, padding the missing binary information of the data to the total number of the segments by a filling pattern of a corresponding number of binary information pieces, wherein the filling pattern includes a number of binary information pieces that corresponds to the total number of the segments and is first written into the segment, and wherein the binary information of the data is subsequently written into the same segment, the particular binary information of the filling pattern being overwritten by the binary information of the data.

7. The method as recited in claim 6, wherein:
the binary information pieces include bytes.

8. The method as recited in claim 6, wherein the binary information of the filling pattern and the binary information of the data are written in a buffer memory into the segment, and the segment is transmitted from the buffer memory to the bus system.

9. The method as recited in claim 6, wherein the bus system is a time-controlled bus system, and the segments correspond to time slots on the bus system, the data being transmitted in the corresponding time slots.

10. A device for padding segments for transmitting data on a bus system, the segments having a predetermined total number of binary information pieces, comprising:
a first arrangement for transmitting the data in the segments; and
a second arrangement for, in the event of transmission of data including less binary information than the predetermined total number of the segment, padding the missing binary information of the data to the total number of the segment through a filling pattern of a corresponding number of binary information pieces, wherein the second means first writes the filling pattern, whose number of binary information pieces corresponds to the total number of the segment, into the segment and subsequently writes the binary information of the data into the same segment, the particular binary information of the filling pattern being overwritten by the binary information of the data.

11. The device as recited in claim 10, wherein:
the binary information pieces include bytes.

12. A bus system, comprising:
a device for padding segments for transmitting data on the bus system, the segments having a predetermined total number of binary information pieces, the device including:
a first arrangement for transmitting the data in the segments; and
a second arrangement for, in the event of transmission of data including less binary information than the predetermined total number of the segment, padding the missing binary information of the data to the total number of the segment through a filling pattern of a corresponding number of binary information pieces, wherein the second means first writes the filling pattern, whose number of binary information pieces corresponds to the total number of the segment, into the segment and subsequently writes the binary information of the data into the same segment, the particular binary information of the filling pattern being overwritten by the binary information of the data.

13. The bus system as recited in claim 12, wherein:
the binary information pieces include bytes.
